(19) United States
(12) Patent Application Publication
(10) Pub. No.: US 2002/0115418 A1
(43) Pub. Date: Aug. 22, 2002

(54) Alternative system switching

(76) Inventor: Jens Wildhagen, Weinstadt (DE)

Correspondence Address: FROMMER LAWRENCE & HAUG LLP, 745 FIFTH AVENUE, NEW YORK, NY, 10151, US

(21) Appl. No.: 10/077,415

(22) Filed: Feb. 15, 2002

(30) Foreign Application Priority Data
Feb. 16, 2001 (EP) 01 103 896.5

(51) Int. Cl. H04B 17/02

(52) U.S. Cl. 455/133; 455/3.02

(57) ABSTRACT

A broadcast receiver designed according to a two tuner concept for alternative broadcast frequency or system switching comprises a delay unit (3) receiving an output signal of the first tuner (1) and an output signal of the second tuner (2) to compensate a time delay between said both output signals. Preferrably, an additional amplitude adaptation unit (4) connected after said delay unit (3) compensates an amplitude difference between said both time delay compensated output signals.

### DESCRIPTION

The present invention relates to a broadcast receiver, in particular to a broadcast receiver capable of receiving a broadcast program via different transmission channels to select the one with the highest reception quality. Further, the present invention relates to a method to switch such a broadcast receiver from one transmission channel to another transmission channel.

Alternative frequency switching strategies are widely used today, for example in FM-broadcasting. Here, a transmitter transmits a list of alternative frequencies on which transmitters at other locations transmit the same program. A receiver checks the signal quality of these alternative frequencies from time to time and switches to an alternative frequency with better signal quality in case of a bad reception situation. Depending on the receiver architecture, such a switching from one frequency to another frequency is more or less audible. In a single tuner concept usually a very short program break occurs and in a two tuner concept the switching is nearly not audible for the listener.

Today most radio stations do not only transmit the same program on alternative frequencies of one broadcast system, e.g. FM, but are simulcasting, i.e. transmitting the same program also on different broadcast systems, e.g. on a digital system like DAB, ISDB-Tn, IBOC or DAM and FM at the same time. However, the switching from one broadcast system to another broadcast system produces big distortions today.

Therefore, it is the object underlying the present invention to provide an alter25 native frequency and/or alternative broadcast system switching strategy which produces less audible distortions.

According to the present invention this object is solved by a broadcast receiver according to independent claim 1 and a switching strategy defined in inde30 pendent claim 10. Preferred embodiments thereof are respectively defined in the respective following dependent claims. A computer program product according to the present invention is defined in claim 19.

A broadcast receiver according to the present invention comprises a first tuner receiving a broadcast program on a predetermined frequency of a predetermined broadcast system, a second tuner receiving said broadcast program on an alternative frequency of said predetermined broadcast system or of an alternative broadcast system, and a delay unit receiving an output signal of said first tuner and an output signal of said second tuner to compensate a time delay between said both output signals.

Corresponding, the method to switch a broadcast receiver from a first tuner receiving a broadcast program on a predetermined frequency of a predetermined broadcast system to a second tuner receiving said broadcast program on an alternative frequency of said predetermined broadcast system or of an alternative broadcast system according to the preent invention comprises the step of compensating a time delay between an output signal of said first tuner and an output signal of said second tuner.

Therefore, according to the present invention a time delay between the output signals of a first tuner and a second tuner is compensated. This compensation eliminates the effects of different receiver concepts for different broadcast systems and different transmission or propagation times of the signal via different transmission channels, e.g. different frequencies of one broadcast system or different broadcast systems. E.g. digital receivers usually delay the audio signal more than analog receivers. The delay in digital receivers is caused by a time interleaver that is required to reduce the distortions caused by fading effects in a mobile communication channel. Preferrably, the output signal of the second tuner is “shifted” so that it corresponds to that of the first tuner to which the user currently listens.

According to a preferred embodiment of the broadcast receiver according to the present invention additionally comprises an amplitude adaptation unit receiving an output signal of said first tuner and an output signal of said second tuner via said delay unit to compensate an amplitude difference between said both time delay compensated output signals.

Corresponding, a preferred embodiment of the method according to the present invention additionally comprises the step of compensating an amplitude difference between said time delay compensated output signals of said first tuner and of said second tuner.

Therefore, according to this preferred embodiment of the present invention also an amplitude difference between said both time delay compensated output signals is compensated, preferrably so that the amplitude of the time delay compensated output signal of the second tuner gets adapted to that of the first tuner. This eliminates changes of an output level of the receiver in case of switching from one broadcast frequency or system to another, since different amplitudes of audio signals transmitted with different broadcast systems are eliminated which are likely possible.

Therewith, the present invention, in particular according to this preferred embodiment, enables to switch for example from a digital system like DAB to another digital system like DAM or to an analog system like FM or AM without audible distortions in the audio signal. Therewith, the present invention allows a kind of broadcast system diversity to avoid distortions or loss of the audio signal in case of bad reception situations. According to the the present invention the repeating of parts of the audio signal (audio frame repetition) or muting of the audio signal in case of bad reception situations which is widely used in today's digital systems, e.g. DAB, can be avoided, since audio data from another broadcast system or channel can be used to fill the missing audio data, e.g. FM-audio data can be used to fill missing DAB audio data.

As stated above, the broadcast receiver according to the present invention comprises two tuners, in particular a first tuner receiving a broadcast program on a predetermined frequency of a predetermined broadcast system and a second tuner receiving said broadcast program on an alternative frequency of said predetermined broadcast system or of an alternative broadcast system.

According to a further preferred embodiment of the present invention the time delay between said both output signals of the first tuner and the second tuner is determined by a correlation. In this case the determined correlation peak describes the time delay between both output signals. Further preferably, respective mono signals of said both output signal of the first tuner and the second tuner are correlated to avoid distortions in the correlation result.

According to a further preferred embodiment of the present invention preferably said output signal of the first tuner is delayed in case it advances the output signal of the second tuner and the output signal of the second tuner is delayed in case it advances the output signal of the first tuner. Alternatively, also an initial delay can be provded for both output signals which ensure that also “negative” delays can be realized by relatively adjusting the delay times, i.e. “advancing” the output signal which needs the negative delay by reducing its initial delay.

Preferably, variable delay elements are used to provide the respectively needed delay which is preferably once determined and then constantly applied, but which also can be constantly determined to avoid distortions by switching from one tuner to another tuner with a delay time which is not actual. Of course, also strategies are possible according to which the delay time is determined and updated not constantly, but in regular time intervals.

In case the output signal of the second tuner, i.e. the tuner to which the broadcast receiver switches, has to be delayed a constant delay is provided at once. On the other hand, in case the output signal of the first tuner has to be delayed a constant delay might be provided at once, e.g. upon switching on the broadcast receiver, or by resampling said output signal of the first tuner with a higher sampling rate, i.e. interpolation, for a predetermined period of time till the full delay is achieved and thereafter with a constant delay, or by repeating a predetermined number of single audio samples of said output signal of said first tuner till the full delay is achieved and thereafter with a constant delay so that the output signal of the first tuner which is output to the user undergoes not audible or nearly not audible changes to provide the delay.

Furthermore, according to a preferred embodiment of the present invention the amplitude difference between said both time delay compensated output signals of the first tuner and the second tuner gets compensated on basis of a difference signal between said both time delay compensated output signals of said first tuner and of said second tuner. A subtractor which determines that difference signal further preferably receives a respective lowpass filtered mono signal of said time delay compensated output signals of said first tuner and of said second tuner to avoid distortions in an amplitude calculation circuit. Still further preferably, multipliers which preferably adapt the output signal of the second tuner so that an amplitude thereof equals to an amplitude of said output signal of said first tuner are arranged so that the amplitude equalization can be made by minimizing the difference signal of both output signals of said first tuner and of said second tuner, i.e. the multipliers are arranged in the signal flow before the signals for the subtractor which determines the difference signal are branched off.

Of course, the above described features and/or embodiments can also be combined in any way to obtain an embodiment with various advantages.

Further features and advantages of the broadcast receiver and method to switch a broadcast receiver according to the present invention will be elucidated from the following description of exemplary embodiments thereof taken in conjunction with the accompanying

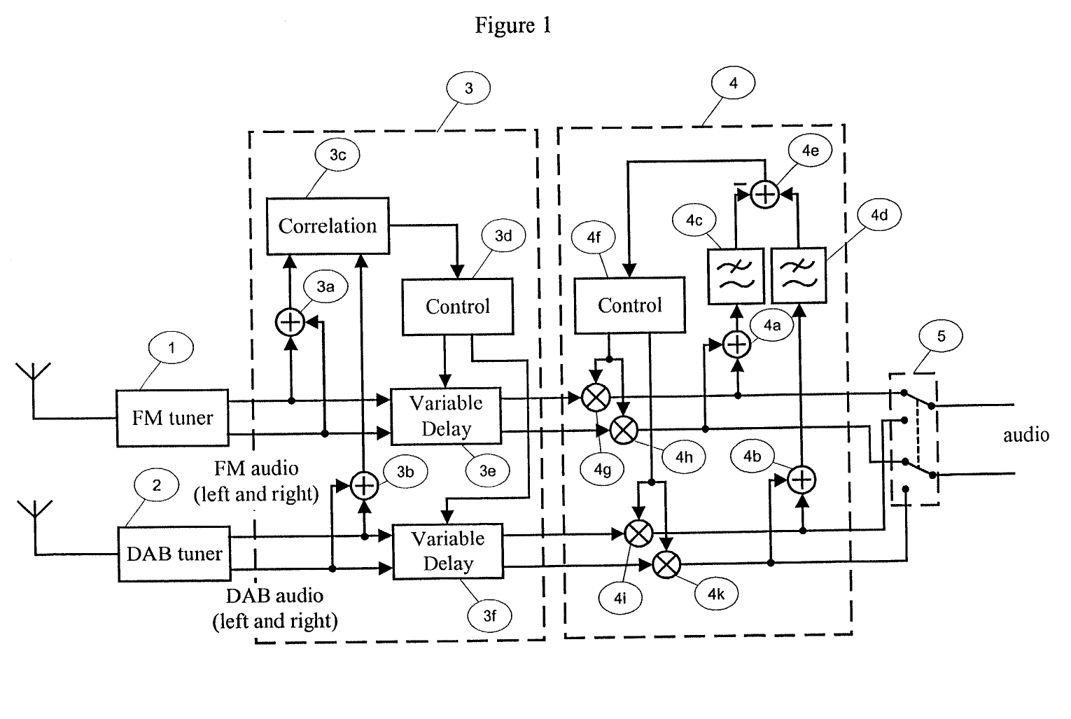

FIG. 1 which shows a preferred embodiment of a broadcast receiver according to the present invention.

The shown broadcast receiver according to a preferred embodiment of the present invention is realized as a 2 tuner concept, namely a FM tuner 1 and a DAB tuner 2. One tuner receives the current program, e.g. the DAB tuner 2 receives the current program transmitted in DAB (in this reception situation the DAB tuner 2 is the first tuner). The other tuner is tuned to the same program in another broadcast system, e.g. the FM tuner 1 receives the same program in FM (in this reception situation the FM tuner 1 is the second tuner). As described before, most likely a time difference between the audio signals of both broadcast systems exists so that it is not possible to switch the output audio signal from the DAB tuner 2 to a FM tuner 1 without distortions.

According to the present invention the time difference between both audio signals is equalized by a delay unit 3 connected to the FM tuner 1 and the DAB tuner 2. The time difference is calculated by correlation. Therefore, the audio signal of the DAB signal output by the DAB tuner 2 is correlated with the audio signal of the FM signal output by the FM tuner 1 by a correlation unit 3c. Since both tuners output a stereo audio signal, preferably the mono signal (left +right audio signal) is used for the correlation to avoid distortions in the correlation result. Therefore, both parts of the output signal of the FM tuner 1, i.e. the left audio signal and the right audio signal, are input to a first adder 3a which outputs a mono signal corresponding to the output signal of the FM tuner 1 to the correlation unit 3c. Similar, both components of the output signal of the DAB tuner 2, i.e. the left audio signal and the right audio signal, are input to a second adder 3b which outputs a mono signal corresponding to the output signal of the DAB tuner 2 to the correlation unit 3c. The correlation result, i.e. the correlation peak, describes the time delay between the DAB audio signal and the FM audio signal. The correlation result is fed to a first control unit 3d which controls a first variable delay element 3e arranged in the signal path of the FM tuner 1 after both signal components of the output signal of the FM tuner 1 are branched off to the first adder 3a and a second variable delay element 3f arranged in the signal path of the DAB tuner 2 after both signal components of the output signal of the DAB tuner 2 are branched off to the second adder 3b. Depending on the sign of the time delay, the DAB output signal or the FM output signal need to be delayed, at least relatively to each other. As mentioned above, usually the DAB output audio signal is delayed to the FM output audio signal due to the time interleaver arranged within the DAB tuner 2. This time delay is equalized by delaying the FM audio signal by the time that is calculated in the correlation circuit. To allow a complete distortionless switching from one tuner to the other an amplitude adaptation unit 4 is arranged in the signal path behind the above-described delay unit 3. The amplitude adaptation unit 4 compensates an amplitude difference between said both time delay compensated output signals of the FM tuner 1 and the DAB tuner 2 which are output by the delay unit 3. This adjustment of the amplitude is preferably performed by minimizing the difference signal between the time delay compensated output signals of the FM tuner 1 and the DAB tuner 2. To avoid distortions in the amplitude calculation/comparison, preferably the time delay compensated lowpass filtered mono audio signals are used. Therefore, a third adder 4a receives both time delay compensated output signals of the FM tuner 1 to determine the time delay compensated mono audio signal of the FM tuner 1 before it is input into a first lowpass filter 4c. Similar, a fourth adder 4b receives both signal parts of the time delay compensated output signal of the DAB tuner 2 to calculate the delay compensated mono audio output signal of the DAB tuner 2 before it is input to a second lowpass filter 4d. The output signals of the first lowpass filter 4c and the second lowpass filter 4d are input into a subtractor 4e which determines the difference signal between the FM audio signal and the DAB audio signal. In the shown embodiment the output signal of the first lowpass filter 4c is used as subtrahend whereas the output signal of the second lowpass filter 4d is used as minuend. The lowpass filtering has two advantages:

The circuit for the comparison of the amplitudes is insensitive to small time differences between the DAB audio signal and the FM audio signal, and

different frequency responses of the analog and digital broadcast systems do not disturb the circuit for the comparison of the amplitudes: Due to the pre-emphase and de-emphase filters in combination with a limitation to a maximum frequency deviation of the FM transmitter in FM broadcast, it is not possible to transmit high frequencies in FM with the same amplitude as they are transmitted in digital systems like DAB.

To avoid amplitude changes in the tuned audio program, only the amplitude of the alternative frequency—in this example the amplitude of the FM audio signal—is adjusted. For the adjustment the difference signal output by the subtractor 4e is input to a second control unit 4f which outputs a first control signal to a first multiplier 4g and a second multiplier 4h which are respectively arranged in one part of the time delay compensated output signal of the FM tuner 1 and a second control signal to a third multiplier 4i and fourth multiplier 4k which are respectively arranged in one part of the time delay compensated output signal of the DAB tuner 2. The first to fourth multipliers 4g to 4k are respectively arranged in the signal paths of the output signal of the tuners before the input signals to the subtractor 4e are branched off to easily achieve an amplitude control by minimization of the difference signal.

Once the broadcast receiver has calculated the correct delay and amplification/attenuation values, these values are kept constant. The receiver can now switch from one tuner to the other, i.e. from the DAB tuner 2 to the FM tuner 1 without audible distortions. The switching is performed by a switching unit 5 which is connected after the amplitude adaptation unit 4 and which receives both components of the time delay compensated amplitude adjusted output signal of the FM tuner 1 and both components of the time delay compensated amplitude adjusted output signal of the DAB tuner 2 to select both components of one thereof as audio output signal.

As elucidated above, this technique can be used to switch from DAB to FM, e. g. in case of a bad reception situation for DAB. The receiver can switch from DAB to FM for example depending on the error rate. Whenever the DAB tuner 2 has a high error rate or loses synchronization, the receiver switches from DAB tuner 2 to the FM tuner 1 to avoid distortions or interruption of the audio signal. The switching time period could be as short as just a few audio samples or an audio frame.

In the following a second reception situation is elucidated according to which the broadcast receiver shown in FIG. 1 switches from the FM tuner 1 (in this reception situation the FM tuner 1 is the first tuner) to the DAB tuner 2 (in this reception situation the DAB tuner 2 is the second tuner).

In case of reception of an FM program, the receiver switches automatically to DAB to receive the best audio quality. Therefore, according to the present invention the timing and the amplitude of the FM audio signal and the DAB audio signal are equalized. As also mentioned above, generally the DAB signal is delayed to the FM signal due to the time interleaver comprised in the DAB tuner 2. Therefore, the DAB signal would have to be delayed with a negative delay in case the FM signal should be left undelayed, which is of course not possible. Therefore, the FM audio signal has to be delayed although this signal is currently heard by a user. Therefore, the following three control strategies are advantageously implemented within the first control module 3d.

1. The FM signal is delayed at once. This can e.g. be done at the beginning, when the listener tunes to the FM station. Therefore, the receiver needs to know the delay between the FM audio signal and the DAB audio signal and needs to delay the FM audio signal with this delay. This information can be stored in the memory of the receiver. Information is calculated once and stored in the receiver like it is done today with the station name in some FM receivers. Another possibility is to delay the audio signal once and to accept that the audio signal is disturbed once. A further possibility is to provide delay lines for both tuners and to tap the output signals e.g. in the middle of each delay line so that also “negative” delays are possible for the output signal of the second tuner.

2. The FM signal is delayed by resampling the audio signal with a higher sampling rate (interpolation) for a limited time period. The interpolation with a small interpolation factor is not audible. The same effect can be achieved by reduction of the audio DAC (digital to analog converter) sampling rate for a limited time period.

3. A simple method repeats the single audio samples in the audio data. In other words, the delay is changed slowly. The distortions are almost not audible - depending on background noise, e.g. determined via the speed of a car in which the reciver is used, the delay is changed.

As indicated in the general description of the present invention, a broadcast receiver according to the present invention can of course also be used to switch from one digital system to another digital system. There is no limitation to switch from DAB to FM and vice versa. Of course, also a switching to other systems like AM, DRM, . . . is possible.

1. Broadcast receiver, comprising:
a first tuner (1) receiving a broadcast program on a predetermined frequency of a predetermined broadcast system,
a second tuner (2) receiving said broadcast program on an alternative frequency of said predetermined broadcast system or of an alternative broadcast system, and
a delay unit (3) receiving an output signal of said first tuner (1) and an output signal of said second tuner (2) to compensate a time delay between said both output signals.

2. Broadcast receiver according to claim 1, characterized by
a correlation unit (3c) within said delay unit (3) to determine the time delay between said output signal of said first tuner (1) and said output signal of said second tuner (2).

3. Broadcast receiver according to claim 2, characterized in that
said correlation unit (3c) receives a respective mono signal of said output signal of said first tuner (1) and of said output signal of said second tuner (2).

4. Broadcast receiver according to anyone of claims 1 to 3, characterized by
a first variable delay element (3e) within said delay unit (3) to delay said output signal of said first tuner (1) in case said output signal of said first tuner (1) advances said output signal of said second tuner (2), and
a second variable delay element (3f) within said delay unit (3) to delay said output signal of said second tuner (2) in case said output signal of said second tuner (2) advances said output signal of said first tuner (1).

5. Broadcast receiver according to claim 4, characterized in that
said first variable delay element (3e) delays said output signal of said first tuner (1) with a constant delay at once, by resampling said output signal of said first tuner (1) with a higher sampling rate, i.e. interpolation, for a predetermined periode of time till the full delay is achieved and thereafter with a constant delay, or by repeating a predetermined number of single audio samples of said output signal of said first tuner (1) till the full delay is achieved and thereafter with a constant delay, and
said second variable delay element (3f) delays said output signal of said second tuner (2) with a constant delay at once.

6. Broadcast receiver according to anyone of the preceding claims, characterized by
an amplitude adaptation unit (4) receiving an output signal of said first tuner (1) and an output signal of said second tuner (2) via said delay unit (3) to compensate an amplitude difference between said both time delay compensated output signals.

7. Broadcast receiver according to claim 6, characterized by
a subtracter (4e) within said amplitude adaptation unit (4) to determine a difference signal between said time delay compensated output signals of said first tuner (1) and of said second tuner (2).

8. Broadcast receiver according to claim 7. characterized in that
said subtracter (4e) receives a respective low pass filtered mono signal of said time delay compensated output signals of said first tuner (1) and of said second tuner (2).

9. Broadcast receiver according to claim 7 or 8, characterized by
respective multipliers (4i, 4k) in the signal path of said output signal of said second tuner (2) to multiply said output signal so that an amplitude of said output signal of said second tuner (2) gets adapted to an amplitude of said output signal of said first tuner (1).

10. Method to switch a broadcast receiver from a first tuner (1) receiving a broadcast program on a predetermined frequency of a predetermined broadcast system to a second tuner (2) receiving said broadcast program on an alternative frequency of said predetermined broadcast system or of an alternative broadcast system, comprising the step of:
compensating a time delay between an output signal of said first tuner (1) and an output signal of said second tuner (2).

11. Method according to claim 10, characterized by
determining the time delay between said output signal of said first tuner (1) and said output signal of said second tuner (2) by a correlation.

12. Method according to claim 11, characterized by
determining a respective mono signal of said output signal of said first tuner (1) and of said output signal of said second tuner (2) to perform the correlation based thereon.

13. Method according to anyone of claims 10 to 12, characterized by
delaying said output signal of said first tuner (1) in case said output signal of said first tuner (1) advances said output signal of said second tuner (2), and
delaying said output signal of said second tuner (2) in case said output signal of said second tuner (2) advances said output signal of said first tuner (1).

14. Method according to claim 13, characterized in that
said output signal of said first tuner (1) gets delayed with a constant delay at once, by resampling said output signal of said first tuner (1) with a higher sampling rate, i.e. interpolation, for a predetermined periode of time till the full delay is achieved and thereafter with a constant delay, or by repeating a predetermined number of single audio samples of said output signal of said first tuner (1) till the full delay is achieved and thereafter with a constant delay, and
said output signal of said second tuner (2) gets delayed with a constant delay at once.

15. Method according to anyone of the preceding claims 10 to 14, characterized by
compensating an amplitude difference between said time delay compensated output signals of said first tuner (1) and of said second tuner (2).

16. Method according to claim 15, characterized by
determining a difference signal between said output signal of said first tuner (1) and said output signal of said second tuner (2).

17. Method according to claim 16, characterized by
determining a respective low pass filtered mono signal of said output signal of said first tuner (1) and of said output signal of said second tuner (2) to determine the difference signal between said output signals based thereon.

18. Method according to claim 16 or 17, characterized by
multiplying said output signal of said second tuner (2) so that an amplitude of said output signal of said second tuner (2) gets adapted to an amplitude of said output signal of said first tuner (1).

19. Computer program product, characterized by computer program means adapted to perform the method steps defined in anyone of claims 10 to 18 when it is executed on a computer, digital signal processor or the like.
